(19) United States
(12) Patent Application Publication
(10) Pub. No.: US 2006/0093732 A1
(43) Pub. Date: May 4, 2006

(54) Ink-jet printing of coupling agents for trace or circuit deposition templating

(76) Inventors: David Schut, Philomath, OR (US); Niranjan Thirukkovalur, Corvallis, OR (US); Ronald A. Hellekson, Eugene, OR (US); Philip Harding, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/976,461

(22) Filed: Oct. 29, 2004

(51) Int. Cl. B05D 5/12

(52) U.S. Cl. 427/58

(57) ABSTRACT

Systems and methods for forming templates for trace or circuit deposition are described. Specifically, a method of forming a template for trace or circuit deposition can comprise steps of jetting an ink-jettable composition onto a substrate in a predetermined pattern, wherein the ink-jettable composition includes a liquid vehicle and at least one coupling agent dispersed therein. The substrate can include functional groups interactive with the coupling agent, wherein upon contact between the coupling agent and the substrate after the jetting step, the coupling agent becomes attached or attracted to the substrate. The method can also include the step of contacting the coupling agent with a metal-containing composition such that a metal of the metal-containing composition becomes attached or attracted to the coupling agent.

### FIELD OF THE INVENTION

The present invention relates generally to the printing of circuitry. More specifically, the present invention relates to forming metallic templates using ink-jet technology for trace or circuit deposition.

### BACKGROUND OF THE INVENTION

Ink-jet printing involves the placement of small drops of a fluid ink onto a media surface in response to a digital signal. Common ink-jet printing methods include thermal ink-jet and piezoelectric ink-jet technologies. Typically, the fluid ink is placed or jetted onto the surface without physical contact between the printing device and the surface. There are several reasons that ink-jet printing has become a popular way of recording images on various media surfaces, particularly paper. Some of these reasons include low printer noise, capability of high-speed recording, and multi-color recording. Additionally, these advantages can be obtained at a relatively low price to consumers.

Production of circuits and conductive traces has been accomplished in many different ways, and various methods for manufacturing printed circuit boards are known. Typical methods for manufacturing printed circuits include print and etch, screen printing, and photoresist methods, e.g., applying photoresist, exposing, and developing. Frequently, these methods involve considerable capital costs and restrictions on production times.

In recent years, various ink-jet technologies have been used to form circuitry. These ink-jet technologies include a variety of methods which have met with varying degrees of success. For example, certain methods have disadvantages which limit their effectiveness, such as expense, reliability, and complexity. Accordingly, investigations continue into developing improved circuit fabrication techniques and compositions for use in ink-jet technologies.

### SUMMARY OF THE INVENTION

It has been recognized that it would be advantageous to develop improved methods for forming conductive patterns, such as traces and/or circuits.

In one aspect of the present invention, a method of forming a template for trace or circuit deposition can comprise steps of jetting an ink-jettable composition onto a substrate in a predetermined pattern, wherein the ink-jettable composition includes a liquid vehicle and at least one coupling agent dispersed therein. The substrate can include functional groups interactive with the coupling agent, wherein upon contact between the coupling agent and the substrate after the jetting step, the coupling agent becomes attached or attracted to the substrate. The method can also include the step of contacting the coupling agent with a metal-containing composition such that a metal of the metal-containing composition becomes attached or attracted to the coupling agent.

Additional features and advantages of the invention will be apparent from the detailed description which illustrates, by way of example, features of the invention.

### DETAILED DESCRIPTION OF THE PREFERRED EMBODIMENT(S)

Before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

In describing and claiming the present invention, the following terminology will be used.

The singular forms “a,” “an,” and “the” include plural referents unless the context clearly dictates otherwise. Thus, for example, reference to “a silane coupling agent” includes reference to one or more of such materials.

As used herein, “liquid vehicle” is defined to include liquid compositions that can be used to carry coupling agents, and optionally other ingredients, such as colorants, to a substrate. In one specific embodiment, the liquid vehicle can also carry a metal-containing composition as well. Liquid vehicles are well known in the art, and a wide variety of ink vehicles may be used in accordance with embodiments of the present invention. Such liquid vehicles may include a mixture of a variety of different agents, including without limitation, surfactants, solvents, co-solvents, buffers, biocides, viscosity modifiers, stabilizing agents, and water. Though a variety of agents are described that can be used, the liquid vehicle, in some embodiments, can be simply a single liquid component, such as water.

“Metal-containing composition” includes metallic nanoparticles, metal salts, organometallic complexes, or the like. These metal-containing compositions are typically contacted with a coupling agent at a substrate site after coupling agent ink-jet deposition. However, the metal-containing composition can also be included with the coupling agent in an ink-jettable liquid vehicle.

The term “coupling agent” refers to any composition in accordance with the present invention that can be ink-jetted from ink-jet architecture, e.g., thermal or piezo ink-jet architecture, and which can maintain its coupling properties upon the thermal and/or shears stresses of the jetting process. Coupling agents are at least interactive, and preferably reactive, with both a substrate to which the coupling agent is applied, and to a metal present in a metal-containing composition, e.g., metallic nanoparticles, metal salts, organometallic complexes, etc. In other words, coupling agents are configured to act as a bridge for attracting or attaching metals to desired locations of a larger substrate.

As used herein, “electroless deposition” refers to any chemical deposition process as opposed to an electrodeposition process. Typically, electroless deposition processes involve acid baths containing metal ions, however other such processes known to those skilled in the art are considered within the scope of the present invention. Electroless deposition is typically carried out in accordance with embodiments of the present invention after metallic nanoparticles or other metals are attracted or attached to a substrate using an ink-jetted coupling agent. Electroless deposition does not include the use of a liquid suspension of metallic nanoparticles to attach seed nanoparticle material to a substrate through coupling agents. Electroless deposition typically follows this process, and includes forming electrical conductive paths using the metallic nanoparticles bound to a substrate as the template.

The term “interactive” includes any type of attraction between at least two compositions or compounds, including reactions. Interactive compositions or compounds can be attracted by van der Waals forces, ionic attraction, and/or covalent attachment, for example.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of about 1% to about 20% should be interpreted to include not only the explicitly recited concentration limits of 1% to about 20%, but also to include individual concentrations such as 2%, 3%, 4%, and sub-ranges such as 5% to 15%, 10% to 20%, etc.

With these definitions in mind, a method of forming a template for trace or circuit deposition can comprise steps of jetting an ink-jettable composition onto a substrate in a predetermined pattern, wherein the ink-jettable composition includes a liquid vehicle and at least one coupling agent dispersed therein. The substrate can include functional groups interactive with the coupling agent, wherein upon contact between the coupling agent and the substrate after jetting, the coupling agent becomes attached or attracted to the substrate. The method can also include the step of contacting the coupling agent with a metal-containing composition such that a metal of the metal-containing composition becomes attached or attracted to the coupling agent. In one embodiment, the template can be used to form a trace or circuit by depositing a trace metal on the template, thereby forming the conductive pathway. This can be carried out by electroless deposition, soldering, electroplating, or other known method. Further, the coupling agent can be contacted with the metal-containing composition in the liquid vehicle prior to jetting, or can be contacted with the substrate simultaneously or after the coupling agent is contacted with the substrate.

In another embodiment, a system for forming a template for trace or circuit deposition can comprise ink-jet architecture containing an ink-jettable composition, a substrate suitable for carrying circuitry, and a metal-containing composition. The ink-jet architecture can be configured to jet the ink-jettable composition in a predetermined pattern, and the ink-jettable composition can include a liquid vehicle and a coupling agent dispersed therein. The substrate can be configured to receive the predetermined pattern, and can include functional groups interactive with the coupling agent. Thus, upon contact between the coupling agent and the substrate upon receiving the predetermined pattern, the coupling agent can become attached or attracted to the substrate. The metal-containing composition can include a metal interactive with the coupling agent, wherein upon contact between the metal-containing composition, the coupling agent, and the substrate, the metal of metal-containing composition can become attached or attracted to the substrate through the coupling agent. In one embodiment, the template formed using this system can be used to form a trace or circuit by depositing a trace metal on the template, thereby forming the conductive pathway. This can be carried out using electroless deposition, soldering, electroplating, or other known method. Again, the coupling agent can be contacted with the metal-containing composition in the liquid vehicle prior to jetting, or can be contacted with the substrate simultaneously or after the coupling agent is contacted with the substrate.

Coupling Agent

As previously described, coupling agents, in accordance with embodiments of the present invention, are compositions that can be ink-jetted from ink-jet architecture, e.g., thermal or piezo ink-jet architecture, and which can maintain their coupling properties upon the thermal and/or shear stresses of the jetting process. Typically, coupling agents are at least interactive, and often reactive, with both a substrate to which the coupling agent is applied, and to a metal of the metal-containing composition, e.g., metallic nanoparticles. In other words, coupling agents are configured to act as a bridge for attracting or attaching metals to desired locations of a larger substrate.

There are various classes of coupling agents that can be used in accordance with embodiments of the present invention, such as silane coupling agents and organic coupling agents. Different coupling agents are effective with certain specific types of substrates, and consideration of the type of coupling agent for use will be dependent on two other materials that may be used, i.e. the surface composition of the substrate and the metals selected for use.

Exemplary substrates that can be used in accordance with embodiments of the present invention include those made from glasses, ceramics, organic polymers, inorganic polymers, cellulose, silicon, and mixtures thereof. Several exemplary metallic nanoparticles, metals salts, and organometallic complexes that can be used include copper, gold, palladium, nickel, silver, rhodium, platinum, magnetic alloys such as Co—Fe—B, Co—Ni—P, Co—Ni—Fe—B, Ni—Co, particulate blends thereof, and alloys thereof; CuSO₄, PdCl₂, AgNO₃, HAuCl₄, and combinations thereof; and silver salts of organic acids (C₃-C₁₈), metallic coordination complexes of diketones such as Cu(acetylacetonate)₂, Pd(acetylacetonate)₂, Pt(acetylacetonate)₂, Pt(1,1,1,5,5,5-hexafluoroacetylacetonate), and combinations thereof.

To cite specific examples of selections of appropriate coupling agents as they relate to specific substrates and metals, the following is illustrative. For example, regarding interactions between the coupling agents and various substrates, silane coupling agents are more effective for use with glass substrates, and organic coupling agents are more effective for use with materials such as polyethylenes, polypropylenes, polycarbonates, acrylics including polymethyl methacrylates polyimides (such as Kapton from E. I. du Pont de Nemours and Company), polyesters, polyethylene naphthalates (PEN), polyethylene terephthalates (PET), terephthalates, polyimides, and copolymers thereof. Regarding interaction potential with certain metals, e.g., metallic nanoparticles or salts, amine-containing coupling agents are effective for attracting silver, gold, copper, palladium, and platinum. Carboxylic acid-containing coupling agents (or salts thereof) are effective for attracting silver and metallic cations, phosphines are effective for chelation of metallic reagents containing metals such as silver, gold, copper, palladium, and platinum, whereas thiol-containing coupling agents are effective for attracting gold, but can be used for the other metals as well.

Referring specifically to silane coupling agents, many organosilane reagents can be used in accordance with embodiments of the present invention. In one embodiment, the silane coupling agents or organosilane reagents can be amine-containing silanes, thiol-containing silanes, or carboxylic acid-containing silanes (or salts thereof. In a more detailed embodiment, the amine-containing silanes can be a primary amine, though secondary or tertiary amines can also be used. Examples of amine-containing silanes include 3-aminopropyltrimethoxysilane, N-(2-aminoethyl-3-aminopropyltrimethoxysilane, 3-(triethoxysilylpropyl)-diethylenetriamine, poly(ethyleneimine)trimethoxysilane, aminoethylaminopropyl trimethoxysilane, and aminoethylaminoethylaminopropyl trimethoxysilane.

Other silane coupling agents or organosilane reagents can also be used that will bridge a substrate to a metallic composition in accordance with embodiments of the present invention. To illustrate this, Formula 1 provides examples of silane coupling agents that can be used: 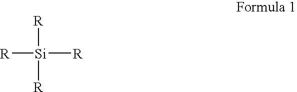
In Formula 1 above, from 0 to 2 of the R groups can be H, —CH₃, —CH₂CH₃, or —CH₂CH₂CH₃; from 1 to 3 of the R groups can be halide or alkoxy; and from 1 to 3 of the R groups can include an active or functional moiety, such as one described previously, e.g., amines, phosphines, thiols, carboxylic acids, or salts thereof. If halide is present, then Formula 1 can be said to be an organohalosilane reagent. If alkoxy is present, then Formula 1 can be said to be an organoalkoxysilane reagent.

Exemplary silane coupling agents that are both reactive with a substrate that includes surface hydroxyl groups, such as glass, and which can maintain an active or functional group for attracting certain metals such as metallic nanoparticles or salts, are illustrated as Formulas 2-5 below:

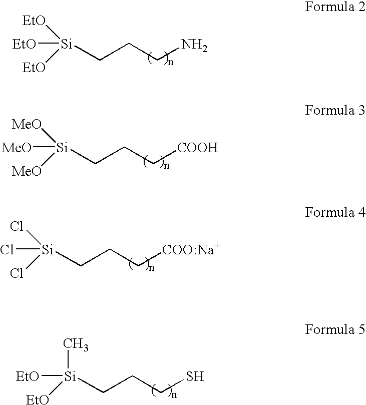

In Formulas 2-5 above, n can be from 0 to 3, for example. It should be noted that Formulas 2-5 are exemplary only, as each contain two or three groups reactive with a hydroxyl-containing substrate, e.g., groups including —O-ethyl,

—O-methyl, or —Cl, though only a single group reactive with the substrate would also be functional. Additionally, other reactive groups can also be used, as is known in the art. Each composition shown also includes only one active group for interaction with a metal, such as a metallic nanoparticle or salt. The active group can be one of those shown or it may include a similar moiety, generally including such moieties as amines, carboxylic acids, a carboxylic acid sodium salts, or thiols. Though only one active group is shown in each of Formulas 2-5, up to three active or functional groups that would be interactive with a metal can be present. The limiting factor in this particular embodiment being that a silane coupling agent can only accommodate four groups attached to the silicon atom, and at least one can be interactive with the substrate, and at least one can be interactive with the metal that will be attached or attracted to the substrate through the silane coupling agent.

In an alternative embodiment, organic coupling agents can be used to bridge an organic polymeric substrate to a metal from a metal-containing composition. Regarding the interaction or reaction of these organic coupling agents to the metal, similar principles apply as described previously with respect to the silane coupling agents. Amines, carboxylic acids (and their salts), and/or thiols can be used to attract or react with the metal-containing compositions in accordance with embodiments of the present invention.

Regarding the interaction of silane coupling agents and organic coupling agents with certain substrates, the coupling agent can either be reactive with the substrate to form a covalent bond, or can merely be attractive to the substrate. For example, a monofunctionalized organic coupling agent can be configured such that the functionalized end, e.g., amine, carboxylic acid or salt thereof, or thiol, is attractive or reactive with a metal to be applied thereto, and the free tail or alkyl end of the organic coupling agent can be configured to interdisperse into a polymeric substrate, such as a polymeric film. Alternatively, organic coupling agents can be configured with a functional group that is particularly reactive with a predetermined substrate, and have an opposing active group that is particularly functional for interaction with a predetermined metallic nanoparticle, for example. Examples of both types of organic coupling agents are shown in Formulas 6-11, as follows: 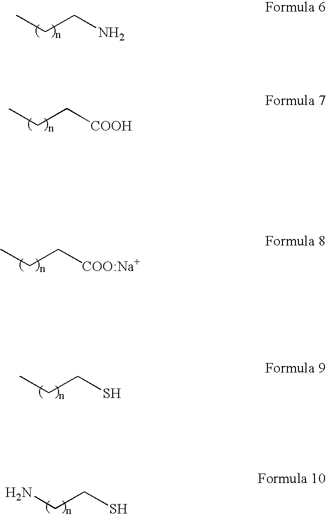
In Formulas 6-11, each n can independently be from 1 to 4, for example. Formulas 6-9 are mono-functionalized, and thus, would be more effective for use with substrates low in polarity to those that are non-polar. In this embodiment, the mono-functionalized coupling agents include a free alkyl tail which can interdisperse into the polymeric films, similar to the manner in which a plasticizer functions. This activity can create a strong enough interaction with a more non-polar substrate, such as a non-polar film surface, to be attracted to the substrate. Thus, the remaining functional group of the coupling agent remains free to interact or react selectively with a metal, such as a metallic nanoparticle. Alternatively, charged substrates (or films) can also be used, such as salts of polyacrylic acid, salts of polysulfonic acids, and polymers containing very polar substitutents (such as polyallylamine or polyethylenediamine).

Conversely, Formulas 10-11 have two functional groups, and in the embodiments shown, the two functional groups are different, though this is not strictly required. One reason for selecting two different functional groups is so that one of the functional groups will be more interactive with the substrate, and the other will be more interactive with a metal to be attached or attracted to the coupling agent. In this manner, one can control both the attachment to the substrate, while maintaining good attraction capability with respect to the metal that will also be attached or attracted to the coupling agent.

Citing a specific example, regarding silane coupling reagents (such as Silquest A-1100, which is a gamma-aminopropyl triethoxysilane coupling agent), typical substrates that can be used include silicon oxide materials such as glass or silicon with a thin layer of oxide built up on the surface. In this configuration, Si—OH bonds at the surface can be bound to the silane groupings of the coupling agents, providing a functionalized surface that is reactive towards organometallics, inorganic metal cations, and/or metallic nanoparticles. Further, the use of silanes can be extended to crosslinking applications, as silane coupling agents can crosslink with adjacent silane coupling agents, forming a siloxane net-like structure. Such a polymer, through interaction of van der Waal forces (with non-oxide substrates) or siloxane formation (with oxide substrates), can increase the adhesive properties of the generated film.

In more detail regarding the use of silane coupling agents with non-oxide substrates, it should be noted generally that although certain types of substrates and certain types of metals have been described for use with specific types of coupling agents, other combinations are still possible for use. To illustrate, silane coupling agents can also be effective for use with substrates other than those with surface hydroxyls. For example, though silane coupling agents will not typically form actual covalent bonds with plastic materials, silane coupling agents can form a polymer matrix or net including interconnecting siloxane groups. This matrix can increase the van der Waals interaction between the resultant polymer matrix or net of multiple silane coupling agents and a plastic substrate. In this respect, the use of silane coupling agents is not limited to use with substrates which have traditionally been considered to be reactive with organosilane reagents, provided there is at least some attraction or interaction between the substrate and the silane coupling agent(s). More generally, regarding coupling agents that are not derivatized by halide or alkoxy groups, interaction of the coupling agent with a substrate can take place via van der Waal interactions, tail integration, wrapping with the substrate (in the case of aliphatic amines), Tr Tr stacking (in the case of aromatic materials), or even hydrogen bonding interactions. In other words, any surface that can be functionalized with coupling agent(s) to increase the interaction of the resultant organometallic, inorganic cation, or metallic nanoparticle material with the substrate is within the scope of the present invention.

Ink-Jettable Composition

The ink-jettable composition in accordance with embodiments of the present invention includes, at minimum, the coupling agent and a liquid vehicle for carrying the coupling agent. The coupling agent, which has already been discussed, can be present in the liquid vehicle at from 0.001 wt % to 10 wt %.

Regarding the liquid vehicle, this liquid can be merely a single solvent such as deionized water, or more likely, can include a variety of components such as those typically used in ink-jet liquid vehicles. Examples of such materials include, but are not limited to, solvents, cosolvents, surfactants, biocides, buffers, viscosity modifiers, sequestering agents, colorants, stabilizing agents, humectants, water, binders, and mixtures thereof. Typically the ink-jettable compositions of the present invention have viscosities of 0.8 to about 8 centiPoise (cP). In one aspect of the present invention, the liquid vehicle can comprise from about 70% to about 98% by weight of the ink-jettable composition. In addition to the liquid vehicle components, other materials can also be present in the ink-jettable composition, including solids such as polymers, and colorants such as dyes and/or pigments.

As described, cosolvents can be included in the ink-jettable compositions of the present invention. Suitable cosolvents for use in the present invention include water soluble organic cosolvents, but are not limited to, aliphatic alcohols, aromatic alcohols, diols, glycol ethers, poly(glycol) ethers, lactams, formamides, acetamides, long chain alcohols, ethylene glycol, propylene glycol, diethylene glycols, triethylene glycols, glycerine, dipropylene glycols, glycol butyl ethers, polyethylene glycols, polypropylene glycols, amides, ethers, carboxylic acids, esters, organosulfoxides, sulfones, alcohol derivatives, carbitol, butyl carbitol, cellosolve, ether derivatives, amino alcohols, and ketones. For example, cosolvents can include primary aliphatic alcohols of 30 carbons or less, primary aromatic alcohols of 30 carbons or less, secondary aliphatic alcohols of 30 carbons or less, secondary aromatic alcohols of 30 carbons or less, 1,2-diols of 30 carbons or less, 1,3-diols of 30 carbons or less, 1,5-diols of 30 carbons or less, ethylene glycol alkyl ethers, propylene glycol alkyl ethers, poly(ethylene glycol) alkyl ethers, higher homologs of poly(ethylene glycol) alkyl ethers, poly(propylene glycol) alkyl ethers, higher homologs of poly(propylene glycol) alkyl ethers, lactams, substituted formamides, unsubstituted formamides, substituted acetamides, and unsubstituted acetamides. Specific examples of cosolvents that can be used in the practice of this invention include, but are not limited to, 1,5-pentanediol, 2-pyrrolidone, 2-ethyl-2-hydroxymethyl-1,3-propanediol, diethylene glycol, 3-methoxybutanol, and 1,3-dimethyl-2-imidazolidinone. Cosolvents can be added to reduce the rate of evaporation of water in the composition to minimize clogging or other properties of the composition such as viscosity, pH, surface tension, optical density, and print quality. The cosolvent concentration can range from about 0 wt % to about 50 wt %, and in one embodiment can be from about 15% to about 30% by weight. Multiple cosolvents can also be used, wherein each cosolvent can be typically present at from about 2% to about 10% by weight of the ink-jettable composition.

Many of the above-listed cosolvents that can be used are also humectants, and many other humectants can also be used. Examples of humectants that can be used include, but not limited to N-containing ketones such as 2-pyrrolidinone, N-methyl-2-pyrrolidinone, 1,3-dimethylimidazolid-2-one, and octylpyrrolidinone; diols such as ethanediols (e.g., 1,2-ethanediol), propanediols (e.g., 1,2-propanediol, 1,3-propanediol), butanediols (e.g., 1,2-butanediol, 1,3-butanediol, 1,4-butanediol), pentanediols (e.g., 1,2-pentanediol, 1,5-pentanediol), hexanediols (e.g., 1,2-hexanediol, 1,6-hexanediol), heptanediols (e.g., 1,2-heptanediol, 1,7-heptanediol), and octanediols (1,2-octanediol, 1,8-octanediol); triols such as 2-ethyl-2-hydroxymethyl-1,3-propanediol and ethyl hydroxypropanediol (EHPD); and glycol ethers and thioglycol ethers. These ethers can consist of polyalkylene glycols such as polyethylene glycols (e.g., diethylene glycol (DEG), triethylene glycols, tetraethylene glycols), polypropylene glycols (e.g., dipropylene glycol, tripropylene glycol, tetrapropylene glycol), polymeric glycols (e.g., PEG 200, PEG 300, PEG 400, PPG 400), and thioglycol. Further, anti-kogation reagents that can also be used include trisodium phosphate (Na₃PO₄), potassium phosphate (K₃PO₄), ammonium nitrate (NH₄NO₃) and phytic acid (available from Aldrich).

Various buffering agents can also be optionally used in the ink-jettable compositions of the present invention. Typical buffering agents include such pH control solutions as hydroxides of alkali metals and amines, such as lithium hydroxide, sodium hydroxide, and potassium hydroxide; and other basic or acidic components. If used, buffering agents typically comprise less than about 10% by weight of the ink-jettable composition.

In another aspect of the present invention, various biocides can be used to inhibit growth of undesirable microorganisms. Several non-limiting examples of suitable biocides include benzoate salts, sorbate salts, commercial products such as NUOSEPT (Nudex, Inc., a division of Huls America), UCARCIDE (Union Carbide), VANCIDE (RT Vanderbilt Co.), and PROXEL (ICI Americas) and other known biocides. Typically, such biocides comprise less than about 5% by weight of the Ink-jettable composition and often from about 0.1% to about 0.25% by weight.

In one aspect of the present invention, the ink-jettable compositions can optionally contain surfactants, such as nonionic, cationic, anionic, or amphoteric surfactants. Such components can be used and may include standard water-soluble surfactants such as alkyl polyethylene oxides, alkyl phenyl polyethylene oxides, polyethylene oxide (PEO) block copolymers, acetylenic PEO, PEO esters, PEO amines, PEO amides, and dimethicone copolyols. If used, surfactants can be from 0.01% to about 10% by weight of the ink-jettable composition. More specifically, suitable surfactants include, secondary alcohol ethoxylates (e.g., Tergitol series available from Union Carbide Co.), nonionic fluorosurfactants (e.g., FC-170C available from 3M), nonionic fatty acid ethoxylate surfactants (e.g., Alkamul PSMO-20 available from Rhone-Poulenc), fatty amide ethoxylate surfactants (e.g., Aldamide L-203 from Rhone-Poulenc), and acetylenic polyethylene oxide surfactants (e.g., Surfynol series available from Air Products & Chemicals, Inc.). Examples of anionic surfactants include alkyl diphenyl oxide surfactants (e.g., Calfax available from Pilot), and Dowfax (e.g., Dowfax 8390 from Dow), and fluorinated surfactants (e.g., Fluorad series available from 3M). Cationic surfactants that may be used include betaines (e.g., Hartofol CB45 available from Hart Product Corp., Mackam OCT-50 available from Mcintyre Group Ltd., Amisoft series available from Ajinomoto), quaternary ammonium compounds (e.g., Glucquat series available from Amerchol, Bardac and Barquat series available from Lonza), cationic amine oxides (e.g., Rhodamox series available from Rhone-Poulenc), Barlox series available from Lonza), and imidazoline surfactants (e.g., Miramine series available from Rhone-Poulenc, Unamine series available from Lonza).

Regarding the process of ink-jetting the ink-jettable compositions of the present invention, an ink-jet printer, for example, can be used to propel ink-jet compositions onto substrates using resistive heating elements or piezoelectric elements for propelling the composition through an overlying orifice plate. The ink-jet compositions can be stored in a reservoir and the composition can travel through a set of channels toward the orifice plate. In connection with the present invention, the printhead can have a firing chamber reservoir containing the ink-jettable composition. The ink-jettable composition can include the liquid vehicle and the coupling agent dispersed therein, as described previously. In one embodiment, the metal-containing composition can be present in the liquid vehicle as well, though this approach may be less effective in some respects with respect to colloidal stability. Still, such embodiments are included to the extent that a stable ink-jettable composition can be formed that contains both coupling agents and metal-containing compositions.

The above described components can be incorporated into flatbed printers or standard ink-jet printers which have been modified to print on rigid or flexible substrates, such as glass, optical disks, circuit boards, polymer films including flex circuits, etc. Generally, a modified ink-jet printer would include inserts which securely hold and move such substrates past the ink-jet printheads. Drop volumes from 2 to 36 pL can be used, though volumes outside of this range are within the scope of the present invention.

It should be noted that either aqueous liquids or organic liquids can be used to jet coupling agents in accordance with embodiments of the present invention. However, different conditions may be desired for different types of compositions. For example, with respect to silane coupling agents, the activation temperature may be about 120° C. in an aqueous solution, whereas with a non-aqueous solution, the activation temperature may be about 80° C. Benefits of using aqueous solutions include its beneficial properties with thermal ink-jet pens, which are typically designed for best thermal interactions with aqueous media. Thus, typically, aqueous solutions can be jetted at a higher rate of speed as the printhead does not heat up as quickly and tends to dissipate heat into the ink faster than organic liquids. Further, aqueous liquids can provide a more reliable control over drop size for similar reasons. This being stated, both non-aqueous compositions and aqueous compositions for jetting coupling agents are both considered to be part of the present invention.

Specific examples of ink-jettable compositions having a coupling agent dispersed therein include the following. In one embodiment, the ink-jettable composition can include approximately 0.15 wt % γ-aminopropyl triethoxysilane (commercially available as Silquest A1100), 5 wt % water, and the remainder (approximately 95%) ethanol. In another embodiment, the ink-jettable composition can include approximately 1.5 wt % γ-aminopropyl triethoxysilane, 5 wt % 1,5-pentanediol, and the remainder water. It will be appreciated by those skilled in the art that various coupling agent solutions may be used and formulations varied.

As a further note, heating of the substrate as printing occurs can be used for various purposes. For example, heat can be used to evaporate solvent, limiting wetting and the corresponding printed feature size. This can eliminate issues related to excessive spreading of the drop(s) upon substrate application. Other methods, such as laser processing conducted in situ will also decrease the effective drop size as the droplet is again evaporated before having a chance to spread over the substrate material. Alternatively, heating can be used to modify the coupling agent in the ink-jet ink. For example, a first lower temperature can be used to evaporate off solvent upon droplet application to a substrate, and a higher temperature can be used to activate a silane coupling agent such that it becomes more reactive with certain metallic nanoparticles or metal salts.

Deposition of Conductive Nanoparticles

Deposition of conductive metals, such as nanoparticles or salts, onto substrates having coupling agents attached or attracted thereto can be carried out by a number of methods, including those methods where a metallic nanoparticle or organometallic complex liquid suspension, or a metal salt solution, is contacted with the coupling agent on the substrate. Such methods for contacting can include dipping or bathing, brushing, pouring, coating, spraying, mixing prior to jetting, separately jetting, or the like. In one embodiment, the coupling agent modified substrate can be dipped in a nanoparticle suspension or salt solution for a period of time such that the metal component of the suspension of solution become attracted or attached to the coupling agent(s). Examples suitable suspensions or solutions for use include the following:

Cu nanoparticles suspended in aqueous solution containing 1 wt % to 15 wt % Cu (available from MicroTech);

Ag nanoparticles suspended in α-terpineol containing 1 wt % to 35 wt % Ag (available from CIMA Nanopowders);

Ag/Cu nanoparticles suspended in propanediol monomethyl ether acetate containing 1 wt % to 35 wt % Ag (available from CIMA Nanopowders);

Ag nanoparticles suspended in propanediol monomethyl ether acetate containing 1 wt % to 35 wt % Ag (available from CIMA Nanopowders);

Ag/Pd nanoparticles suspended in propanediol monomethyl ether acetate containing 1 wt % to 35 wt % Ag (available from CIMA Nanopowders), where Pd helps initiate the catalytic electroless reduction of Cu;

Solutions containing the metallic cations of Cu²⁺, e.g., CuSO₄, Ag⁺, e.g., AgNO₃, and Au³⁺, e.g., HAuCl₄, at concentrations from 10⁻³ M to 10⁻¹ M; and

Solutions containing organometallics such as silver salts of organic acids (C₃-C₁₈), metallic coordination complexes of diketones such as Cu(acetylacetonate)₂, Pd(acetylacetonate)₂, Pt(acetylacetonate)₂, and Pt(1,1,1,5,5,5-hexafluoroacetylacetonate) at concentrations from 10⁻³ M to 10⁻² M.

Deposition of Conductive Pathway

Metals deposited on substrates via coupling agents, as described previously, can be used as a collection of seeds for deposition of a conductive pathway. More specifically, these seeds are attached to or otherwise adhered to the substrate in a predetermined pattern, thereby providing a template for the deposition of a conductive pathway. The conductive pathway can be in the form of metal trace or circuitry element, and preferably in the form of a collection of traces and circuitry elements to form at least one circuit. The non-continuous pattern can be generally formed of a series of dots which are sufficiently close in proximity that deposition of a conductive metal on the seeds or dots will ultimately connect proximate areas to form the conductive pathways as desired.

Deposition of the conductive metal can be accomplished using a variety of known techniques, such as electroless deposition, soldering, and/or electrodeposition. In one aspect of the present invention, the conductive metal can be deposited using an electroless process. Electroless deposition processes generally involve a substrate having a seed metal deposited thereon. The substrate can then be immersed or exposed to a solution of a conductive metal salt and a reducing agent. Specific electroless plating compositions and conditions can be chosen by those skilled in the art to achieve various plating rates, thicknesses, and conductivities. As mentioned, any conductive metal can be used that is capable of being deposited in accordance with embodiments of the present invention. Several exemplary conductive metals include copper, gold, palladium, nickel, silver, rhodium, platinum, magnetic alloys such as Co—Fe—B, Co—Ni—P, Co—Ni—Fe—B, Ni—Co, and mixtures and alloys thereof.

The principles of the present invention can be used to apply a conductive metal to a wide variety of substrates. As mentioned above, in accordance with the present invention, temperatures used in forming conductive pathways are frequently near or even below 80° C. At this relatively low temperature, most substrate materials are typically not adversely affected. As previously stated, substrate materials suitable for use in the present invention can include, without limitation, ceramics, inorganic polymers such as glass, organic polymers such as polyalkylenes, cellulose, silicon, and mixtures thereof. For example, the compositions of the present invention can be printed on a standard silicon substrate, polyethylene terephthalate (available from E. I. du Pont de Nemours and Company as MYLAR), polyimides (available from E. I. du Pont de Nemours and Company as KAPTON), glass, alumina ceramic, or even certain papers. Although the above mentioned substrates are suitable, almost any non-conductive material or flexible or non-flexible dielectric material can be used as the substrate in the present invention, provided the coupling agent used is at least attracted or interactive with the substrate. Alternatively, certain conductive surfaces can be anodized to modify their conductive properties, making the surface non-conductive. An example includes anodized aluminums, including foils. In addition, the methods of the present invention can be applied to substrates having previously formed electronic circuits and/or devices thereon using any known method.

The circuits produced in accordance with the principles of the present invention can form a wide variety of electronic devices and the resolution and complexity of such pathways are only limited by the ink-jet printing technology. Circuit patterns can include, for example, complex circuits, single traces, antennae, or even multilayered circuits. Patterns formed using the ink-jettable composition of the present invention can have a linewidth of from about 30 micrometers to any practical width. Generally, several millimeters is the widest practical width; however, wider conductive pathways could be formed depending on the application. Similarly, the conductive pathway can have varying thicknesses as measured from the substrate to an upper surface of the conductive pathway. The thickness of the conductive metal can be easily controlled by the ink-jetting process during printing of the coupling agent onto the substrate. Likewise, during electroless deposition, the thickness of the conductive metal is governed by the length of time the surface is exposed to the electroless solution, and the particular solution and concentrations used. Typically, thicknesses of from about 0.2 micrometers to about 5 micrometers are desirable for most electronic devices.

Using the methods described herein, almost any known predetermined pattern forming an electronic structure can be prepared, such as, but not limited to, gates, transistors, diodes, resistors, inductors, capacitors, traces, magnets, and other circuit elements. The present invention allows the production of a wide variety of devices in a short period of time and with minimal preparation which normally accompanies standard lithography techniques of preparing a mask, deposition, etching, etc. Thus, prototypes of complex patterns can be tested and adjusted without time consuming lithography steps.

### EXAMPLES

The following examples illustrate embodiments of the invention that are presently best known. However, it is to be understood that the following is only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following examples provides further detail in connection with what are presently deemed to be practical embodiments of the invention.

### Example 1

An ink-jettable composition was prepared that included 1.5 wt % Silquest A-1100, 5 wt % 1,5-pentanediol, 0.5 wt % Tergitol 15-S-5, and the remainder of water. The Silquest A-1100 is a gamma-aminopropyl triethoxysilane coupling agent. The ink-jettable composition was printed in a predetermined pattern on a glass substrate at a drop volume of 6 pL, and the glass maintained at 80° C. temperature during the drop deposition. The drops of the pattern had a 50 to 80 micron diameter on the glass substrate. The silane coupling agent was then activated by application of additional heat (120° C.) to the substrate for 5 minutes.

### Example 2

Fifteen nanoparticle-containing liquid dispersions or salt-containing solutions were prepared. Specifically, three silver nanoparticle-containing liquid suspensions were prepared which included 1 wt %, 5 wt %, and 10 wt % Ag nanoparticles, respectively, each suspended in 1,2-propanediol monomethylether acetate (from CIMA). Three additional silver nanoparticle-containing liquid suspensions were prepared which included 1 wt %, 5 wt %, and 10 wt % Ag nanoparticles, respectively, each suspended in water (from CIMA). Three copper nanoparticle-containing liquid suspensions were also prepared which included 1 wt %, 5 wt %, and 10 wt % Cu nanoparticles, respectively, each suspended in water (from MicroTech). Three palladium and silver nanoparticle-containing liquid suspensions were prepared which included 1 wt %, 5 wt %, and 10 wt % Ag/Pd (5 wt % Pd in Ag) nanoparticles, respectively, each suspended in 1,2-propanediol monomethylether acetate (from CIMA). Two solutions of CuSO₄ salt were prepared, each of which included water and the salt at respective concentrations of 1×10⁻² moles/liter and 1×10⁻³ moles/liter. Two solutions of PdCl₂ salt were also prepared, each of which included water and the salt at respective concentrations of 1×10⁻² moles/liter and 1×10⁻³ moles/liter. Additionally, two solutions of AgNO₃ salt were also prepared, each of which included water and the salt at respective concentrations of 1×10⁻² moles/liter and 1×10⁻³ moles/liter.

### Example 3

Fifteen activated silane coupling agent-printed glass substrates as prepared in Example 1 were, respectively, individually dipped into the fifteen dispersions or solutions described in Example 2. In each case, the metal of the nanoparticles or salts were deposited onto the activated silane coupling agents, producing templates for electroless deposition or other trace or circuit deposition processes.

### Example 4

Templates prepared in accordance with Example 3 can be used to form electrically conductive paths of copper (or other metals) using an electroless deposition process. For example, an electroless deposition bath can be prepared that includes the following concentration of ingredients in water: from 1.8 g/L to 2.2 g/L copper; from 7.0 g/l to 8.0 g/L NaOH; from 2.0 g/L to 3.5 g/L formaldehyde; from 30 g/L to 40 g/L EDTA; and other optional additives known in the art. The bath conditions can be: from 40° C. to 50° C. at a pH of about 13. Additionally, the bath can be agitated under air and/or mechanical agitation, and can be continuously filtered through a 10 micron mesh.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention it will be apparent to those of ordinary skill in the art that numerous modifications can be made without departing from the principles and concepts of the invention as set forth in the claims.

What is claimed is:

1. A method of forming a template for trace or circuit deposition, comprising steps of:
a) jetting an ink-jettable composition onto a substrate in a predetermined pattern, said ink-jettable composition including a liquid vehicle and at least one coupling agent dispersed therein, said substrate including functional groups interactive with said coupling agent, wherein upon contact between the coupling agent and the substrate after jetting, the coupling agent becomes attached or attracted to the substrate; and
b) contacting the coupling agent with a metal-containing composition such that a metal of the metal-containing composition becomes attached or attracted to the coupling agent.

2. A method as in claim 1, wherein the coupling agent is a silane coupling agent.

3. A method as in claim 2, wherein the silane coupling agent is selected from the group consisting of an amine-containing silane coupling agent, a thiol-containing silane coupling agent, and a carboxylic acid-containing silane coupling agent.

4. A method as in claim 1, wherein the coupling agent is an organic coupling agent.

5. A method as in claim 4, wherein the organic coupling agent is selected from the group consisting of an amine-containing organic coupling agent, a thiol-containing organic coupling agent, and a carboxylic acid-containing organic coupling agent.

6. A method as in claim 1, wherein the substrate comprises a material selected from the group consisting of ceramics, organic polymers, inorganic polymers, cellulose, silicon, and mixtures thereof.

7. A method as in claim 6, wherein the substrate comprises an inorganic polymer, said inorganic polymer being glass.

8. A method as in claim 1, wherein the substrate comprises the organic polymer, said organic polymer being selected from the group consisting of polyethylenes, polypropylenes, polyesters, polyethylene naphthalates, polyethylene terephthalates, polyimides, polycarbonates, acrylics, and copolymers thereof.

9. A method as in claim 1, wherein the contacting step occurs after the jetting step.

10. A method as in claim 1, wherein metal-containing composition includes metallic nanoparticles suspended in a liquid in the form of a liquid suspension, and the contacting step is by contacting the liquid suspension with the coupling agent attached to the substrate.

11. A method as in claim 10, wherein the substrate having the coupling agent attached thereto is dipped in the liquid suspension.

12. A method as in claim 10, wherein the liquid suspension includes from 1 wt % to 15 wt % of the metallic nanoparticles.

13. A method as in claim 1, wherein metal-containing composition is a liquid solution.

14. A method as in claim 1, wherein the metal is in the form of metallic nanoparticles.

15. A method as in claim 14, wherein the metallic nanoparticles are selected from the group consisting of copper, gold, palladium, nickel, silver, rhodium, platinum, Co—Fe—B, Co—Ni—P, Co—Ni—Fe—B, Ni—Co, particulate blends thereof, and alloys thereof.

16. A method as in claim 1, wherein the metal is in the form of a metal salt.

17. A method as in claim 16, wherein the metal salt is selected from the group consisting of CuSO₄, PdCl₂, AgNO₃, HfAuCl₄, and combinations thereof.

18. A method as in claim 1, wherein the metal is in the form of an organometallic complex.

19. A method as in claim 18, wherein the organometallic complex is selected from the group consisting of silver salts of organic acids (C₃-C₁₈), metallic coordination complexes of diketones, and combinations thereof.

20. A method as in claim 1, wherein, upon jetting, the coupling agent becomes attached or attracted to the substrate by covalent attachment.

21. A method as in claim 1, wherein the ink-jettable composition further comprises a colorant.

22. A method as in claim 1, wherein the contacting step occurs after the jetting step.

23. A method as in claim 1, wherein the contacting step occurs prior to the jetting step.

24. A method of forming an electrically conductive pathway, comprising steps of:
a) forming a template as in claim 1; and
b) depositing a trace metal on the template to form the conductive pathway.

25. A method as in claim 24, wherein the depositing step is by electroless deposition.

26. A method as in claim 24, wherein the depositing step is by soldering.

27. A method as in claim 24, wherein conductive pathway is thickened by a step of electroplating.

28. A method as in claim 24, wherein the electrically conductive pathway is in the form of a circuit.

29. A system for forming a template for trace or circuit deposition, comprising:
a) ink-jet architecture containing an ink-jettable composition, said ink-jet architecture configured to jet the ink-jettable composition in a predetermined pattern, said ink-jettable composition including:
i) a liquid vehicle, and
ii) a coupling agent dispersed therein;
b) a substrate suitable for carrying circuitry and configured to receive the predetermined pattern, said substrate including functional groups interactive with said coupling agent, wherein upon contact between the coupling agent and the substrate upon receiving the predetermined pattern, the coupling agents become attached or attracted to the substrate; and
c) a metal-containing composition including a metal interactive with the coupling agent, wherein upon contact between the metal-containing composition, the coupling agent, and the substrate, the metal of the metal-containing composition becomes attached or attracted to the substrate through the coupling agent.

30. A system as in claim 29, wherein the coupling agent is a silane coupling agent.

31. A system as in claim 30, wherein the silane coupling agent is selected from the group consisting of an amine-containing silane coupling agent, a thiol-containing silane coupling agent, and a carboxylic acid-containing silane coupling agent.

32. A system as in claim 29, wherein the coupling agent is an organic coupling agent.

33. A system as in claim 32, wherein the organic coupling agent is selected from the group consisting of an amine-containing organic coupling agent, a thiol-containing organic coupling agent, and a carboxylic acid-containing organic coupling agent.

34. A system as in claim 29, wherein the substrate comprises a material selected from the group consisting of ceramics, organic polymers, inorganic polymers, cellulose, silicon, and mixtures thereof.

35. A system as in claim 29, wherein the substrate comprises the organic polymer, said organic polymer being selected from the group consisting of polyethylenes, polypropylenes, polyesters, polyethylene naphthalates, polyethylene terephthalates, polyimides, terephthalates, polyimides, and copolymers thereof.

36. A method as in claim 29, wherein the metal-containing composition includes metallic nanoparticles suspended in a liquid in the form a liquid suspension.

37. A system as in claim 36, wherein the liquid suspension includes from 1 wt % to 15 wt % of the metallic nanoparticles.

38. A system as in claim 29, wherein metal-containing composition is a liquid solution.

39. A system as in claim 29, wherein the metal is in the form of metallic nanoparticles.

40. A system as in claim 39, wherein the metallic nanoparticles are selected from the group consisting of copper, gold, palladium, nickel, silver, rhodium, platinum, Co—Fe—B, Co—Ni—P, Co—Ni—Fe—B, Ni—Co, particulate blends thereof, and alloys thereof.

41. A system as in claim 29, wherein the metal is in the form of a metal salt.

42. A system as in claim 41, wherein the metal salt is selected from the group consisting of CuSO₄, PdCl₂, AgNO₃, HAuCl₄, and combinations thereof.

43. A system as in claim 29, wherein the metal is in the form of an organometallic complex.

44. A system as in claim 43, wherein the organometallic complex is selected from the group consisting of silver salts of organic acids (C₃-C₁₈), metallic coordination complexes of diketones, and combinations thereof.

45. A system as in claim 29, wherein the ink-jettable composition further comprises a colorant.

46. A system as in claim 29, wherein the ink-jettable composition and the metal-containing composition are separate compositions configured for being contacted on or at the substrate.

47. A system as in claim 29, wherein the ink-jettable composition and the metal-containing composition are admixed in the ink-jet architecture.

48. A system for forming trace or circuit, comprising:
a) the system for forming a template of claim 29; and
b) a trace metal configured for deposition on the template.
